(19) United States
(12) Patent Application Publication
(10) Pub. No.: US 2010/0103103 A1
(43) Pub. Date: Apr. 29, 2010

(54) Method And Device for Input Of Information Using Visible Touch Sensors

(76) Inventors: Daniel V. Palanker, Sunnyvale, CA (US); Mark S. Blumenkranz, Portola Valley, CA (US)

Correspondence Address: DLA PIPER LLP (US ), 2000 UNIVERSITY AVENUE, EAST PALO ALTO, CA, 94303-2248, US

(21) Appl. No.: 12/543,368

(22) Filed: Aug. 18, 2009

Related U.S. Application Data
(60) Provisional application No. 61/091,304, filed on Aug. 22, 2008.

(51) Int. Cl. G06F 3/042; G09G 5/08

(52) U.S. Cl. 345/158; 345/175

(57) ABSTRACT

A device and method for manual input of information into computing device using a camera and visible touch sensors. An image of a virtual input device is displayed on a screen, and the positions of the visible touch sensors, recorded by the video camera, are overlaid on the image of the virtual input device, thus allowing the user to see the placement of the touch sensors relative to the keys or buttons on the virtual input device. The touch sensors change their appearance upon contact with a surface, and the camera records their position at the moment of change. This way information about the position of intended touch is recorded. Touch sensors can be binary (ON-OFF) or may have a graded response reflecting the extent of displacement or pressure of the touch sensor relative to the surface of contact.

### RELATED APPLICATIONS

This application claims the benefit of U.S. Provisional Application No. 61/091,304, filed Aug. 22, 2008, and which is incorporated herein by reference.

### FIELD OF THE INVENTION

The present invention relates to methods and devices for producing a virtual computing environment. More specifically, the present invention provide a means for input of information into computer via a video camera, allowing for actuation of a virtual input device displayed on a computer screen or video goggles.

### BACKGROUND OF THE INVENTION

Currently, the standard data input devices for most computers are a keyboard and a pointing device (e.g. mouse, touchpad, trackball, etc.). More recently, tablet computers have been developed that allow for user input by touching a touch sensitive computer screen itself, although most such systems also include the more traditional keyboard and pointing device as well.

As computers get smaller, lighter and more compact, there is a corresponding need to make their data input devices smaller, lighter and more compact as well. However, keyboards, mice, etc. can be made only so small and still be effective. Virtual input device solutions have been developed, as shown and described in U.S. Pat. Nos. 6,037,882; 4,988,981; 5,767,842; 6,611,252; 5,909,210; 5,880,712; 5,581,484; 7,337,410 and 5,168,531. However, these devices and techniques are not ideal because they: have a limited range of input parameters that do not provide an equivalent to a non-virtual keyboard and pointing device, are too complex for smaller computers and applications, require complex set up, are not cost effective, consume too much power for portable applications, require extensive set up, require an extensive hardware input component solution, require extensive computation of sensor position, induce error with certain user gestures, require training of the devices, fail to provide a visual representation of the virtual input devices, and/or require a wired and therefore cumbersome solution.

There is a need for a virtual computer input system that is light, portable, inexpensive, and allows for wireless data input with different types of the input interfaces producible on a display screen (e.g. keyboard, mouse, joystick, sliding controls, music instrument keys, etc.).

### BRIEF SUMMARY OF THE INVENTION

The aforementioned needs are addressed by a system for operating a virtual input device using a surface that includes a sensor configured to change a visible characteristic thereof in response to contacting a surface, a camera for capturing an image of a field of view that includes the sensor, a display for displaying a virtual input device, and at least one processor. The at least one processor is configured to determine from the captured image a relative location of the sensor within the field of view, overlay onto the virtual input device a visual indicator of the sensor at a location on the display that corresponds to the determined relative location, and determine from the image when the visible characteristic changes.

A method of operating a virtual input device using a surface includes placing sensor in a field of view of a camera, wherein the sensor is configured to change a visible characteristic thereof in response to contacting a surface, contacting the sensor to the surface to change the visible characteristic, capturing an image of a field of view using a camera, displaying a virtual input device on a display, determining from the captured image a relative location of the sensor within the field of view, overlaying onto the virtual input device a visual indicator of the sensor at a location on the display that corresponds to the determined relative location, determining from the image when the visible characteristic changes, and activating a portion of the virtual input device proximate to the visual indicator in response to the determined visible characteristic change.

Other objects and features of the present invention will become apparent by a review of the specification, claims and appended figures.

### BRIEF DESCRIPTION OF THE DRAWINGS

FIG. 1 is a diagram illustrating the visible touch sensor input system.

FIG. 2 is a diagram illustrating the relative positioning of the touch sensors and reference markers.

FIG. 3 is a diagram illustrating the relative positioning of the touch sensors overlaid on a keyboard virtual input device displayed on a display.

FIG. 4 is a diagram illustrating the relative positioning of the touch sensors overlaid on a mouse virtual input device displayed on a display.

FIG. 5 is a perspective view of a thimble-shaped touch sensor.

FIG. 6A is a top view of an un-activated hydraulic touch sensor.

FIG. 6B is a top view of an activated hydraulic touch sensor.

FIG. 7A is side cross-sectional view of an un-activated mechanical touch sensor.

FIG. 7B is a top view of the un-activated mechanical touch sensor.

FIG. 7C is side cross-sectional view of an activated mechanical touch sensor.

FIG. 7D is a top view of the activated mechanical touch sensor.

### DETAILED DESCRIPTION OF THE INVENTION

The present invention greatly simplifies and broadens the possibilities of the wireless input devices by overlaying an image of the virtual input device with images of the touch sensors recorded in real time. The touch sensors convey information about intention of the user with regards to each of the input keys or knobs of the virtual input device. Since locations of the touch sensors are recorded with a conventional video camera, such a system can be easily implemented with small mobile computing devices, such as phones and laptops. The touch sensors may not require any power source since they can mechanically change their appearance upon touching a working surface, or generate short pulses of light that consume little electric power.

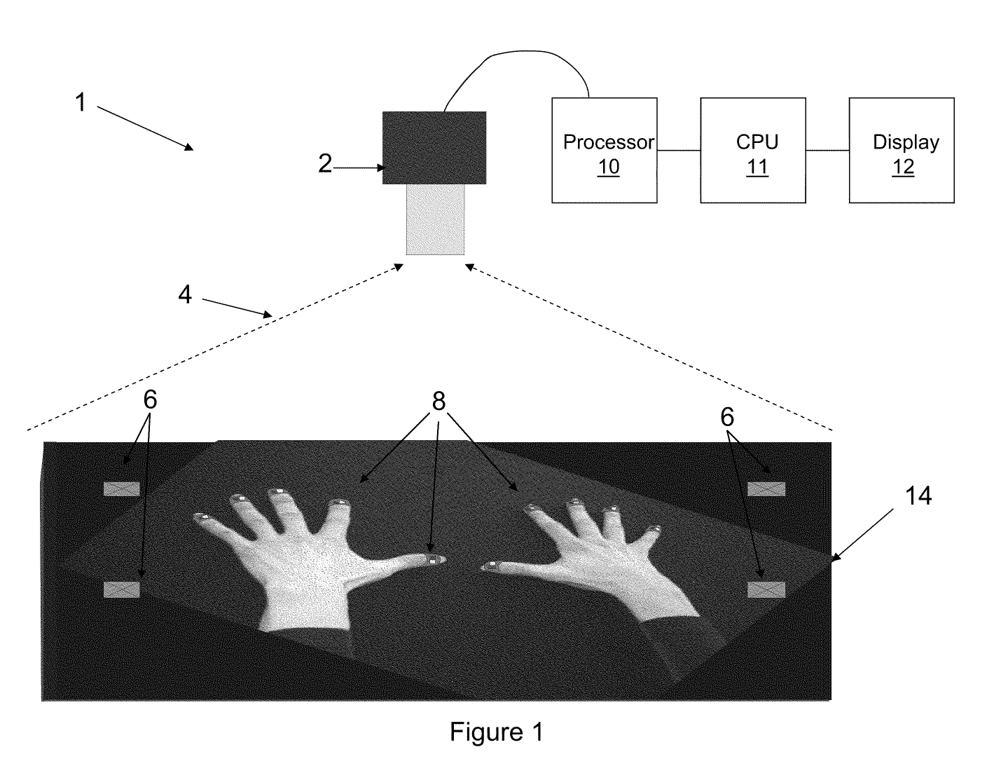

FIG. 1 illustrates the virtual input system 1, which includes a camera 2 having a field of view 4, (position) reference markers 6, touch sensors 8, processor 10, connected to the central processing unit (CPU) of the computer 11, and display 12. Camera 2 can be any image capture device for capturing an image within its field of view 4. Reference markers 6 can be any visible object detectable in the image captured by the camera 2 (i.e. the markers 6 reflect, refract and/or scatter light, and/or emit light). Preferably, the reference markers 6 rest on the working surface 14 on which the touch sensors 8 are operated. Touch sensors 8 preferably attach to the fingertips or other parts of the body. Alternately, touch sensors 8 can attach to writing or drawing instruments such as a pen or stylus. Touch sensors 8 are configured to change at least one visible characteristic such as shape, color, passive light properties (e.g. reflective, refractive or scattering), active light properties (light emission), etc., in response to contact the working surface 14. This state change can be binary (on-off) in response to mere contact with the working surface, and/or can be gradual in proportion to the amount of exerted pressure, or relative displacement, between the touch sensors 8 and the working surface 14. The image of the reference markers 6 and the touch sensors 8 is captured by camera 2 and their relative locations are mapped over to the visual display 12 via processor 10. Processor 10 can be a separate processing device, one integral to the display 12, or even one serving as the central processor for a computer controlled by the virtual input devices. Processor 10 is used to process the image and identify the relative locations of markers 6 and sensors 8 in the image. Display 12 can be a computer display, a stand-alone display or television, a projector, or even a head-mounted display.

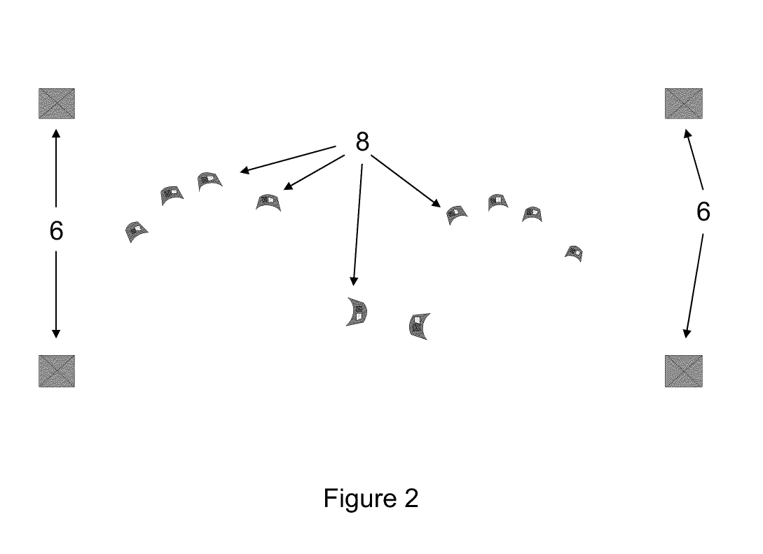

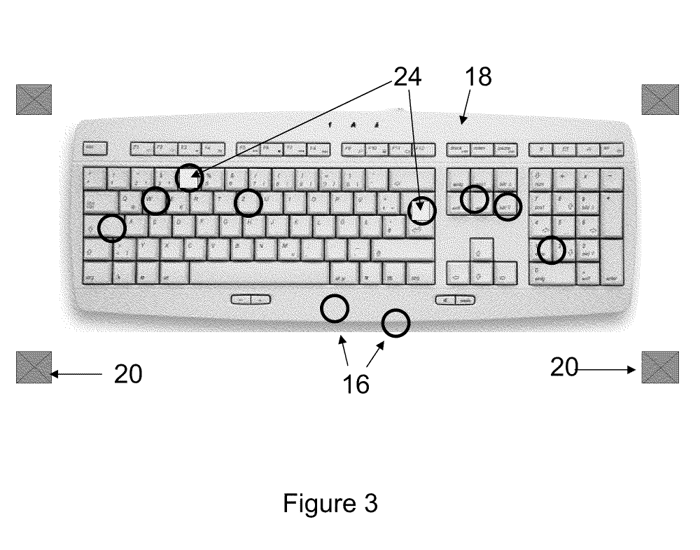

Camera 2 captures the locations of the touch sensors 8 within the field of view 4 (see FIG. 2), and visually displays those locations 16 on display 12 in a manner where the displayed locations 16 are overlaid onto a virtual input device 18 (e.g. an image of a keyboard) also displayed on display 12, as illustrated in FIG. 3. Camera 2 can determine location (and movement) of the touch sensors 8 relative to the working surface 14 in several ways. One location determination technique is to isolate the location of each touch sensor 8 relative to the camera's fixed field of view 4. This technique assumes that the camera position is fixed relative to the working surface 14. Alternately, optional reference markers 6 can be placed in the camera's field of view 4, where the system determines location (and movement) of the touch sensors relative to the reference markers (and thus indirectly with respect to the field of view 4). This technique would compensate for any movements of the camera 2 relative to the working surface 14, and would prevent such movements from affecting the locations of the touch sensors 8 relative to the virtual input device. The locations 20 of the reference markers 6 can be visually displayed on display 12 as shown in FIG. 3.

Camera 2 also detects a change in at least one visible characteristic of the touch sensors 8. When a touch sensor 8 makes contact with working surface 14 (e.g. a table top, etc.) at a particular location in the field of view 4, that touch sensor 8 is configured to change at least one visible characteristic that can be visually discernable in the image captured by camera 2. The system detects that visible characteristic change, and in response deems that touch sensor activated for a certain period of time (typically a fraction of a second). The activation is preferably displayed on display 12. To make sure this event will be reliably detected by the camera 2, the duration of the visible characteristic change preferably exceeds the frame acquisition time (typically between 10 to 100 ms) of camera 2. The touch sensor activation can be binary (i.e. having two states: ON and OFF), or it can have a gradual response in proportion to the deformation (vertical displacement) and/or exerted pressure of the touch sensor 8 relative to the surface 14 it is touching.

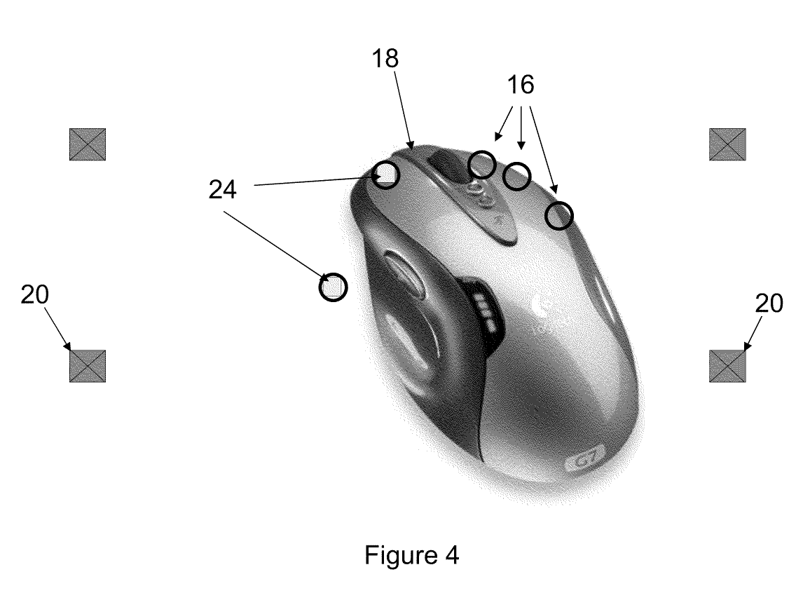

The images of exemplary input devices 18 such as a keyboard or a mouse, as well as the locations 16 the touch sensors 8 on the working surface 14, are shown in an overlaid fashion on the display 12 in FIGS. 3 and 4. The locations 20 of the reference markers 6 are also shown. The system can also be configured to display a simple contour of hands or of another instrument wearing or supporting the touch sensors 8. A user watching display 12 can see the position of the touch sensors 8 relative to the virtual input device 18 (e.g. relative to the keys or buttons of a virtual keyboard or mouse) on the display 12, and can move his fingers over to and activate the desired button or key by touching the corresponding working surface location (i.e. by activating the touch sensor 8 while its location 16 on display 12 is proximate to—i.e. on or within a given proximity to—the desired button or key). The display 12 can visually indicate the activation of a virtual input device button/key by the activation of touch sensors 8 (by changing the visual appearance of those touch sensor locations 16 that have been activated), as indicated by the colored boxes 24 in FIGS. 3 and 4. By touching a touch sensor 8 to the working surface while its location 16 is at or near the location of a button of a virtual mouse, and then sliding the touch sensor along the working surface, a user can drag an object as is commonly done with an actual mouse input device (see FIG. 4).

Preferably, system 1 is configured to allow a user to select one of many different types of virtual input devices, and operate them with various numbers of touch sensors (i.e. as many as one touch sensor for each finger and thumb). For example, a virtual mouse input device can have left and right buttons for the left and right click, as well as a scrolling wheel. To move the virtual mouse input device, the user can touch the working surface 14 with one touch sensor 8 on one finger or thumb, which is away from the buttons or a scrolling wheel, and move the sensor 8 along the working surface 14. The mouse would be shown to the right of the user's thumb, under the index and middle fingers. To activate the left button, the user would position his index finger (containing a touch sensor 8) so that its corresponding location shown on the display 12 is above the left button, and then would touch the working surface 14 with his index finger. Doing the same with the middle finger would activate the right click function. To rotate the scrolling wheel, the user would position his finger (containing a touch sensor 8) such that its corresponding location shown on the display is above the image of the wheel, then touch the working surface 14 with that finger and move it along the working surface 14 in the desired direction of rotation of the wheel.

Another example of a virtual input device is a touch pad, on which the user can directly draw lines with his fingers by touching and dragging one or more touch sensors along the working surface 14. The harder the touch sensors are pressed on the working surface 14, the thicker the line drawn. Symbolic gestures can also be used to control the display of images. For example, positioning the virtual locations of two fingers on the corners of an image and then stretching them outwards would increase the size of the image. A touch sensor 8 can instead be placed on an object such as a stylus or a paintbrush, to make it easier for the user to draw lines and shapes using well known drawing techniques on the working surface 14.

One significant advantage of the system 1 is that it uses a camera, focused on the working surface 14 on which the touch sensors 8 are operated, to detect the location and movement of the touch sensors 8 within the field of view 4. This is done by making the touch sensors 8 visibly discernable relative to the background of the image captured by the camera 2. This visibility allows the system (e.g. processor 10) to visually isolate each touch sensor 8, and determine its location and movement relative to the camera's field of view 4 or relative to the reference markers 6 (which are also visibly isolated in the image of the working surface 14).

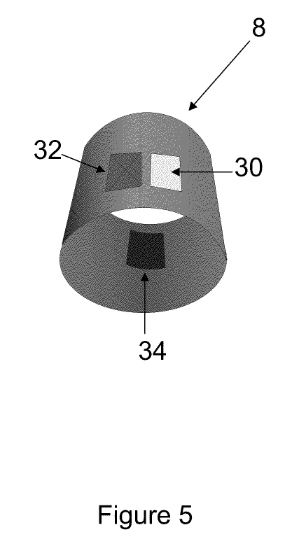

Making touch sensors 8 visible relative to the working surface 14 can be accomplished by using highly reflective materials and/or light emitting devices. FIG. 5 illustrates a thimble-like touch sensor 8 that slides onto the end of the user's finger or thumb. Different colors can be used for different functions. For example, the touch sensor 8 can include a colored reflective pad 30 (e.g. yellow) which the processor 10 can use to determine the location of the touch sensor 8, and a light emitting device 32 (e.g. a light emitting diode, or any other device that can produce electromagnetic radiation that can be detected by camera 2) which activates or changes color in response to contact with (and/or in response to increasing or decreasing pressure relative to) the working surface 14 sensed by a contact or pressure detector 34. For example, the light emitting device can turn green when contact is detected, and changes its appearance (e.g. in terms of color, hue or intensity) as the pressure with the working surface 14 changes. Detector 34 can be a piezo-electric device (or other equivalent device) that not only detects contact with the working surface 14, but produces a signal proportional to the amount the pressure exerted by the user onto the working surface 14 or device deformation (e.g. vertical displacement) relative to the surface of contact. If an RGB camera is used, then it may be preferable to use red to indicate location, green to indicate no contact with the working surface 14, and blue to indicate contact with the working surface 14. Each of the touch sensors 8 can have a unique visible trait or operation so that the processor 10 can distinguish between them. For example, different touch sensors can include unique patterns of reflectivity (e.g. stripes) so that the processor can determine their locations in the image and can distinguish them from each other. Similar techniques can be used for making the reference markers 6 uniquely visible in the image.

The processor 10 determines the boundaries of each visible touch sensor in the captured images in real time, and calculates the position of its centroid (geometric center of the object's shape). The location of the centroid is then displayed on the display 12 with a visual indicator (e.g. a symbol) representing the touch sensor. For example, the symbol could be a circle with a size corresponding to typical finger tip width, as shown as visual indicators 16 in FIG. 3.

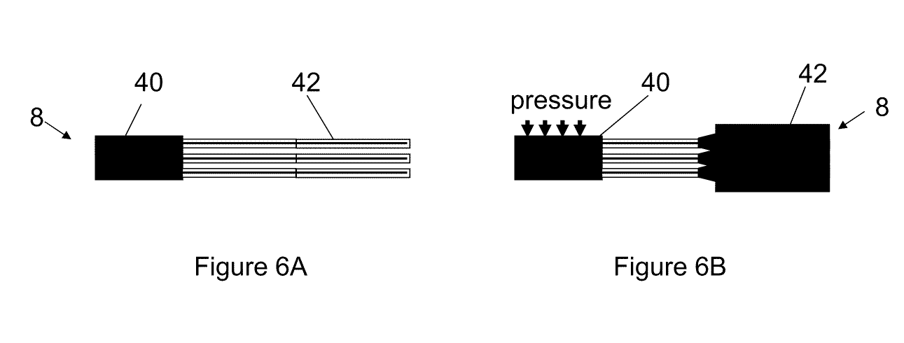

FIG. 5 shows how touch sensors 8 indicate status change (to reflect contact or increased pressure with the working surface 14) electro-optically. Alternately, touch sensors 8 can indicate status change hydraulically or mechanically, which would negate the need for a power source local to the touch sensor 8. For example, FIG. 6A illustrates a hydraulic embodiment of touch sensor 8, which includes a liquid reservoir 40 containing colored liquid. The reservoir 40 is located on a bottom surface of the sensor that makes contact with the working surface 14. Compressing the reservoir (due to contact or pressure with working surface 14) forces the colored liquid into one more transparent capillaries 42 that extend along a surface visible to camera 2, as shown in FIG. 6B. The color change of the capillaries is detected by the camera 2 as a state change of the touch sensor 8.

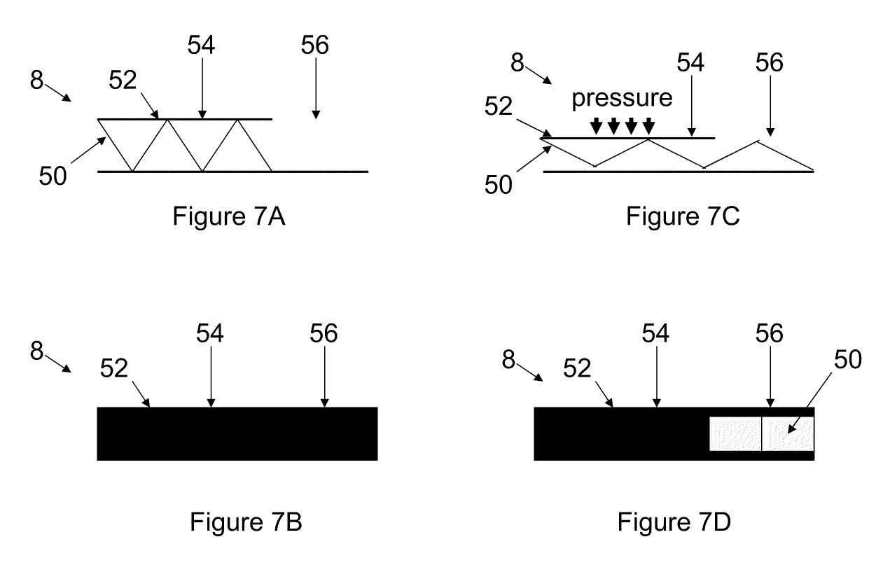

FIGS. 7A and 7B illustrate a mechanical embodiment of touch sensor 8, which includes a spring 50 inside a compressible housing 52 having an opaque portion 54 and a window portion 56 (e.g. either an opening or made of transparent material). When the housing 52 is compressed (against the working surface 14), the spring 50 (which is a different color than the housing 52) is forced out into the window portion 56 of the housing 52 (and thus becomes visible to the camera 2 to indicate a state change of the touch sensor 8) as illustrated in FIGS. 7C and 7D. The amount of color change for the electro-optical, hydraulic and mechanical embodiments of the touch sensors 8 can provide a graded or gradual state change response indication.

The duration of the touch sensor state change can convey information by the user as well. For example, the user can activate the touch sensor at a given location for a prolonged period of time, to indicate a prolonged activation of a particular user interface control. For example, the user can continuously activate a touch sensor 8 over CTRL or Shift keys while operating other keys on a virtual keyboard. Similarly, if the system is used for playing music, the music key on a virtual piano is continuously operated as long as the touch sensor 8 used to operate that music key remains activated. The graded response of the touch sensor 8 may be used to convey information about the force applied to a key, which can also be used for playing virtual musical instruments.

While FIG. 1 illustrates both a processor 10 and computer CPU 11, processor 10 could be omitted, where CPU 11 is the sole processor that performs all of the image analysis and display generation. However, if the flow of video data and processing requirements are too high and overwhelm or slow down the CPU 11, the image processing can shared between separate processors (processor 10 and CPU 11). Information about relative position and status of each touch sensor 8 can be first extracted from the video data by processor 10 prior to being sent to CPU 11. Then, only the coordinates and status of these touch sensors 8 are delivered to CPU 11 in real time, which can avoid overloading the CPU 11 of a computer implementing the virtual input device techniques described herein. Images or symbolic representations 16 and 20 of the touch sensors and reference markers are then shown on the display in the corresponding locations on the virtual input devices by CPU 11.

Applications of system 1 include data entry, free hand drawing or writing, painting, turning and adjusting manual controls of any devices, and playing music. Touch sensors can also be placed on a pen, or another stylus. Information about pressure applied to a paintbrush, or about the intended width of the line can be transmitted by the pressure applied to the working surface 14.

The system 1 can even be used to transform a conventional computer screen into a touch screen, by using the computer screen as the working surface 14. Camera 2 can be configured to monitor the locations of touch sensors 8 that are placed over and make contact with the computer screen. The touch sensors 8 can be used to activate virtual buttons displayed on the computer screen, or used to manipulate the computer screen content (e.g. placing fingers on two corners of an image and moving the fingers outwards while the touch sensors 8 are activated by screen contact to control the stretching the image).

It is to be understood that the present invention is not limited to the embodiment(s) described above and illustrated herein, but encompasses any and all variations falling within the scope of the appended claims. For example, references to the present invention herein are not intended to limit the scope of any claim or claim term, but instead merely make reference to one or more features that may be covered by one or more of the claims.

What is claimed is:

1. A system for operating a virtual input device using a surface, comprising:
a sensor configured to change a visible characteristic thereof in response to contacting a surface;
a camera for capturing an image of a field of view that includes the sensor;
a display for displaying a virtual input device;
at least one processor configured to:
determine from the captured image a relative location of the sensor within the field of view,
overlay onto the virtual input device a visual indicator of the sensor at a location on the display that corresponds to the determined relative location, and
determine from the image when the visible characteristic changes.

2. The system of claim 1, wherein the at least one processor is further configured to activate a portion of the virtual input device proximate to the visual indicator in response to the determined visible characteristic change.

3. The system of claim 2, wherein the portion of the virtual input device is one of a key, a button and a wheel displayed on the display.

4. The system of claim 2, wherein the virtual input device is one of a keyboard, a mouse and a touch pad.

5. The system of claim 2, wherein the sensor is further configured to gradually change the visible characteristic thereof in proportion to an amount of exerted pressure or displacement between the sensor and the surface.

6. The system of claim 5, wherein the at least one processor is further configured to gradually activate the portion of the virtual input device in proportion to the gradual change of the visible characteristic.

7. The system of claim 2, wherein the at least one processor is further configured to visually indicate on the display the activation of the portion of the virtual input device.

8. The system of claim 2, further comprising:
a plurality of reference markers disposed in the field of view and in the image captured by the camera, wherein the at least one processor is configured to determine from the captured image the relative location of the sensor using the reference markers.

9. The system of claim 1, wherein the sensor is configured as a ring for inserting over a user's finger.

10. The system of claim 1, wherein the sensor comprises:
a detector for detecting contact of the sensor to the surface; and
a light source for emitting a light signal in response to the detecting by the detector, wherein the emitted light signal is the visible characteristic change of the sensor.

11. The system of claim 10, wherein the sensor further comprises:
a reflector for reflecting light, wherein the camera captures the reflected light as part of the image, and the at least one processor is configured to use the captured reflected light in determining the relative location of the sensor.

12. The system of claim 1, wherein the sensor comprises:
a compressible housing having a window portion; and
a spring configured to extend into the window portion upon compression of the housing, wherein the extension of the spring into the window portion is the visible characteristic change of the sensor.

13. The system of claim 1, wherein the sensor comprises:
a compressible reservoir containing fluid;
a transparent capillary extending from the reservoir, wherein the fluid flows into the capillary upon compression of the reservoir, and wherein the flow of the fluid into the capillary is the visible characteristic change of the sensor.

14. The system of claim 1, wherein the sensor is a plurality of sensors each of which includes a different color or pattern relative to the other sensors, and wherein the at least one processor is configured to activate different portions or functions of the virtual input device in dependence on the different colors or patterns of the sensors.

15. A method of operating a virtual input device using a surface, comprising:
placing sensor in a field of view of a camera, wherein the sensor is configured to change a visible characteristic thereof in response to contacting a surface;
contacting the sensor to the surface to change the visible characteristic;
capturing an image of a field of view using a camera;
displaying a virtual input device on a display;
determining from the captured image a relative location of the sensor within the field of view;
overlaying onto the virtual input device a visual indicator of the sensor at a location on the display that corresponds to the determined relative location;
determining from the image when the visible characteristic changes; and
activating a portion of the virtual input device proximate to the visual indicator in response to the determined visible characteristic change.

16. The method of claim 15, wherein the portion of the virtual input device is one of a key, a button and a wheel displayed on the display.

17. The method of claim 15, wherein the virtual input device is one of a keyboard, a mouse and a touch pad.

18. The method of claim 15, wherein:
the contacting includes applying a varying amount of exerted pressure or displacement between the sensor and the surface, wherein the sensor is further configured to gradually change the visible characteristic thereof in proportion to the varying amount of exerted pressure or displacement between the sensor and the surface; and
the activating includes gradually activating the portion of the virtual input device in proportion to the gradual change of the visible characteristic.

19. The method of claim 15, further comprising:
visually indicating on the display the activation of the portion of the virtual input device.

20. The method of claim 15, further comprising:
placing a plurality of reference markers in the field of view, wherein the determining from the captured image the relative location of the sensor within the field of view is performed using the reference markers.

21. The method of claim 15, wherein:
the sensor comprises a detector for detecting contact of the sensor to the surface and a light source for emitting a light signal in response to the detecting by the detector; and
the determining from the image when the visible characteristic changes includes detecting the emitted light signal as the visible characteristic change of the sensor.

22. The method of claim 15, wherein:
the sensor comprises a compressible housing having a window portion and a spring configured to extend into the window portion upon compression of the housing; and
the determining from the image when the visible characteristic changes includes detecting the extension of the spring into the window portion as the visible characteristic change of the sensor.

23. The method of claim 15, wherein
the sensor comprises a compressible reservoir containing fluid and a transparent capillary extending from the reservoir such that the fluid flows into the capillary upon compression of the reservoir; and
the determining from the image when the visible characteristic changes includes detecting the flow of the fluid into the capillary as the visible characteristic change of the sensor.

24. The method of claim 15, wherein:
the sensor is a plurality of sensors each of which includes a different color or pattern relative to the other sensors; and
the activating of a portion of the virtual input device comprises activating different portions or functions of the virtual input device in dependence on the different colors or patterns of the sensors.
